(19) United States
(12) Patent Application Publication
(10) Pub. No.: US 2025/0343602 A1
(43) Pub. Date: Nov. 6, 2025

(54) Limiting the gain of a Raman amplifier upon fiber span recovery

(71) Applicant: Ciena Corporation, Hanover, MD (US)

(72) Inventor: Choudhury A. Al Sayeed, Stittsville (CA)

(73) Assignee: Ciena Corporation, Hanover, MD (US)

(21) Appl. No.: 18/655,534

(22) Filed: May 6, 2024

(51) Int. Cl. H04B 10/079; H01S 3/102; H01S 3/30

(52) U.S. Cl. CPC H04B 10/07955; H01S 3/1022; H01S 3/302

(57) ABSTRACT

Systems and methods for clamping Raman gains are provided. According to one implementation, a method includes a step of limiting a gain of a Raman amplifier after maintenance or repair of a fiber span, where the Raman amplifier is configured to amplify optical signals propagating over the fiber span. The method also includes a step of obtaining local power measurements. Based on the local power measurements, the method includes a step of increasing the gain of the Raman amplifier. Furthermore, according to another implementation, an optical amplifier assembly may include a Raman amplifier configured to amplify optical signals propagating over a fiber span and a control device configured to limit a gain of the Raman amplifier after maintenance or repair of the fiber span.

### FIELD OF THE DISCLOSURE

The present disclosure generally relates to optical communication networks. More particularly, the present disclosure relates to systems and methods for powering up a Raman amplifier in a limited manner after issues with a fiber span have been resolved.

### BACKGROUND

In optical communication networks, Raman amplifiers are configured for providing power to long fiber spans to boost optical signals that are propagating along the fiber spans. Fiber spans are optical links that connect two adjacent nodes or Network Elements (NEs), connect a NE with an Intermediate Line Amplifier (ILA), and/or connect one ILA with another ILA. Often, each fiber span can also be amplified by a corresponding Raman amplifier. During maintenance and repairs on the fiber spans, the Raman amplifiers are typically powered off to allow any issues to be fixed. After a fiber span is recovered, the corresponding Raman amplifier is typically restored to its original power level.

### BRIEF SUMMARY

According to one implementation, a process may include a step of limiting a gain of a Raman amplifier after maintenance or repair of a fiber span, whereby the Raman amplifier may be configured to amplify optical signals propagating over the fiber span. The process further includes a step of obtaining local power measurements. Based on the local power measurements, the process further includes a step of increasing the gain of the Raman amplifier.

In some embodiments, the process may be executed by an optical amplifier assembly, which may include the Raman amplifier for amplifying optical signals propagating over the fiber span. Also, the optical amplifier assembly may include a control device, which may be configured to limit a gain of the Raman amplifier after maintenance or repair of the fiber span.

Also, according to further embodiments, the optical amplifier assembly may further include a telemetry receiver (Rx) component configured to obtain power measurements, wherein the control device may be configured to limit the gain of the Raman amplifier to an estimated level based on power measurements. The control device may further be configured to estimate an overall loss of the fiber span based on the power measurements and turn up the gain of the Raman amplifier based on the estimated overall loss. The telemetry Rx component may be configured to output Amplitude Modulated (AM) signals.

Furthermore, the step of limiting the gain may include a sub-step of setting the gain to a reduced level corresponding to a reduced overall loss of the fiber span. Also, limiting the gain may include setting the gain to a level below a prior setting that had been provisioned before the maintenance or repair of the fiber span. The control device may further be configured to read Optical Line Fail (OLF) recovery diagnostics. The maintenance or repair may include reducing an overall loss of the fiber span by performing one or more of a) fixing a fiber cut, b) resplicing a lossy fiber splice, c) reconnecting a loose connector, d) unbending an excessively bent fiber, e) releasing a pinched fiber, f) cleaning an end face of one or more dirty fibers, g) clearing an OLF condition, h) shortening a length of the fiber span, and i) resolving issues in the fiber span that were unknown at the time when the fiber span was initially installed or when the fiber span received any prior maintenance or repair.

In some embodiments, the fiber span may be configured to link an upstream Network Element (NE) with a downstream NE. The optical amplifier assembly, for example, may be part of the downstream NE. The control device may be configured to limit the gain of the Raman amplifier until supervisory-based communications are established with the upstream NE. The control device in some embodiments may be configured to limit the gain to prevent a saturation condition interrupting Optical Supervisory Channel (OSC) communications between the upstream NE and downstream NE. For instance, an optical fiber may be found to be “saturated” when the fiber's capacity to carry data has been fully utilized or overloaded.

In addition, the control device may be configured to recover from an OLF by a) clearing a Loss of Modulation (LOM) fault associated with a telemetry unit or b) clearing a Loss of Frame (LOF) fault associated with an Optical Supervisory Channel (OSC) component. When an Optical Supervisory Channel (OSC) associated with the optical amplifier assembly experiences a Loss of Frame (LOF), the gain may be limited to a minimum of a) a provisioned target gain, b) a maximum achievable Raman gain for a fiber type of the fiber span, and c) an estimated fiber span loss with the Raman amplifier off minus an estimated value that would avoid double Rayleigh Scattering. The estimated fiber span loss with the Raman amplifier off, for example, may be equal to an estimated upstream telemetry transmitter power minus a local telemetry receiver power with the Raman amplifier off.

Furthermore, when an Optical Supervisory Channel (OSC) associated with the optical amplifier assembly does not experience a Loss of Frame (LOF), the gain may be limited, in various embodiments, to a minimum of a) a provisioned target gain and b) a maximum achievable Raman gain for a fiber type of the fiber span. The Raman amplifier may be configured for amplification in a direction that is counter to the propagation of the optical signals being amplified. Also, the Raman amplifier may include one or more pump lasers, wherein limiting the gain of the Raman amplifier may include clamping pump power of the one or more pump lasers regardless of previously provisioned target gains. In some embodiments, the optical amplifier assembly may be housed on a Raman card.

According to some embodiments, alternative processes may be employed. For example, instead of implementing the process, one strategy may include limiting a gain of a Raman amplifier after maintenance or repair of a fiber span, where the Raman amplifier is configured to amplify optical signals propagating over the fiber span. Then, the process may simply include strategically increasing the gain of the Raman amplifier based on local power measurements.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a schematic diagram illustrating a line system configured to conduct a power-up process for a Raman amplifier upon the remediation of issues on a fiber span, according to various embodiments of the present disclosure.

FIG. 2 is a block diagram illustrating computing components of the control device shown in FIG. 1, according to various embodiments.

FIG. 3 is a block diagram illustrating computing components of the management system shown in FIG. 1, according to various embodiments.

FIG. 4 is a flow diagram illustrating a process for powering up a Raman amplifier upon the remediation of issues on a fiber span, according to various embodiments.

FIG. 5 is a flow diagram illustrating a general process for limiting the power of a Raman amplifier after issues in a fiber span are resolved, according to various embodiments.

### DETAILED DESCRIPTION

Raman amplifiers are utilized in optical communication networks for amplifying optical signals that are transmitted over fiber spans (e.g., optical fibers, fiber optic cables, etc.). Again, fiber spans may be used to link one node or Network Element (NE) with another node or NE in a line system, may be used to link an NE with an adjacent Intermediate Line Amplifier (ILA), and/or may be used to link one ILA with another. Typically, for a given fiber span, the gain of a Raman amplifier may be set up to a maximum level for the fiber span in order to reduce effective noise-figure performance in a Raman+Erbium Doped Fiber Amplifier (EDFA) combination.

When maintenance and repairs are performed on a fiber span, the corresponding Raman amplifier is powered off to allow remediation of the various types of issues (e.g., fiber cut, etc.). After a fiber span is recovered, the corresponding Raman amplifier is typically restored to its maximum gain level. However, the action of returning the gain of the Raman amplifier back to its maximum level can introduce new problems in the line system. These new problems have not been recognized until now.

Upon completion of maintenance or repair on a fiber span to fix various issues (e.g., fix a fiber cut), there is a possibility that the overall loss of the fiber span may be reduced. This, of course, may be beneficial in that the line system can transmit optical signals more efficiently and effectively. However, the reduced loss can also create new problems:

1) For example, when an OLF condition is cleared and the Raman amplifier is turned up to its previously provisioned gain level, the gain may then be too high compared to the loss. This excessive gain could result in double Rayleigh Scattering, non-linear penalties for traffic signals, and/or prolonged traffic outage, even after recovery of the fiber span. For example, Rayleigh Scattering in this context refers to the condition when light is scattered by particles or molecules in the light-carrying medium that are much smaller than the wavelength of the light. The term “double Rayleigh Scattering” may refer to a situation where light undergoes multiple scattering events with particles in the medium, resulting in a more complex scattering pattern and/or a higher degree of attenuation.

2) Furthermore, the reduced overall loss in the fiber span could saturate an Optical Supervisory Channel (OSC) at the downstream or receiver (Rx) end of the line system. The OSC Rx, for instance, may not be able to clear a Loss of Clock (LOC) condition. When this happens, the node associated with Raman amplifier may lose communication with its upstream node, including any upstream power notifications for necessary span loss calculations. Also, this may disrupt the view of the network topology of the line system and/or may interrupt control of the fiber span.

There may be any number of ways that the overall loss of a fiber span might be reduced during maintenance and repairs:

1) For example, an initial installation of the line system may have had additional lumped loss in the signal transmit direction that would not prevent the Raman amplifier, operating in a counter-propagating manner, to turn up on the link. Later, if the issue (e.g., fiber pinch, fiber overbending, etc.) is cleared, the overall fiber span loss may be reduced.

2) During the initial installation or a previous repair, an additional fiber spool might be included in the length of fiber span, which increases the overall fiber span loss and would require a larger Raman gain. However, if this extra fiber spool is later removed, thereby reducing the overall loss, the large gain may exceed an acceptable level.

Thus, a specific problem, which had been previously unrecognized until now, involves the powering up of a Raman amplifier after issues in the fiber span have been resolved. While the Raman amplifier is turned off during maintenance and repair actions, the conventional strategies include returning the power or gain of the Raman amplifier back to its previous operating level after the maintenance and repairs are completed. However, if the maintenance and repairs to the fiber span result in a decrease in the overall loss of the fiber span, then the power level of the Raman amplifier may exceed an appropriate level, which can introduce new problems in the line system. Therefore, the present disclosure describes systems and methods for powering up the Raman amplifier in a controlled manner, whereby the gain is clamped (e.g., limited, restricted, etc.) with respect to the previous operating maximum level. That is, the term clamped means to limit, restrict, reduce, etc. the Raman gain to a certain level that is less than the previous operating maximum level.

### Line System with Controlled Raman Gains

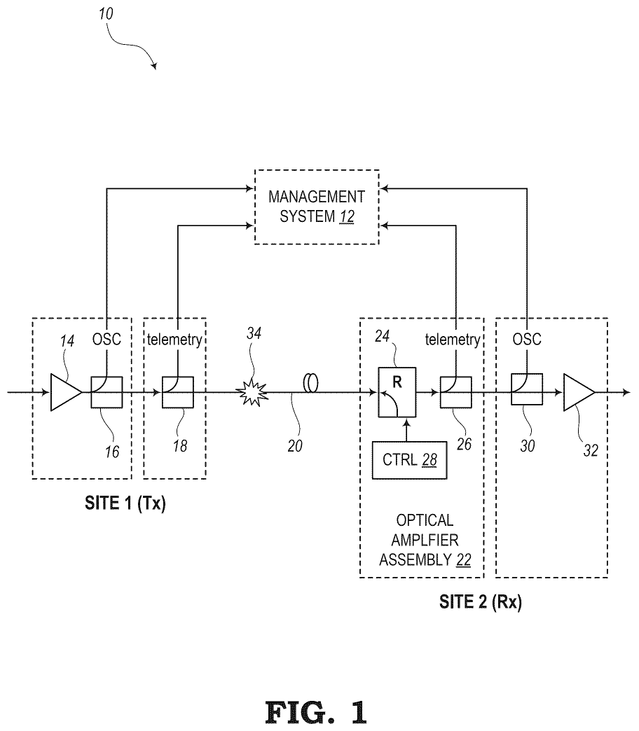

FIG. 1 is a schematic diagram illustrating an embodiment of a line system 10 configured to conduct a power-up process for a Raman amplifier 24 upon the remediation of issues on a fiber span 20 extending from a first site (i.e., Site 1) and a second site (i.e., Site 2). For example, the fiber span 20 links Site 1 with Site 2, where Sites 1 and 2 may be nodes, NEs, ILAs, etc. As shown in this embodiment, the line system 10 includes a management system 12 (e.g., control system, supervisory system, administration system, etc.) configured to receive optical measurements from Optical Supervisory Channel (OSC) components and telemetry units positioned at both Site 1 and Site 2.

As shown, Site 1 includes one component or card including an EDFA 14 and an OSC unit 16. The OSC unit 16 is configured to measure optical parameters along the flow of optical signals being transmitted in a direction from Site 1 to Site 2 (i.e., left to right on the page). Site 1 also includes another component or card having a telemetry unit 18 configured to measure optical parameters associated with Raman amplification on the line system 10. The measured parameters from the OSC unit 16 and telemetry unit 18 may be provided to the management system 12 and may be used to calculate power levels for adjusting a gain level of the Raman amplifier 24, as needed, to maintain the level within an acceptable range (e.g., not too low and not too high).

Site 2, as shown in FIG. 1, includes a first component or card configured as an optical amplifier assembly 22. The optical amplifier assembly 22 includes the Raman amplifier 24, a telemetry unit 26, and a control device 28. A second component or card of Site 2, in this embodiment, includes an OSC unit 30 and an EDFA 32. Measured optical power levels are provided from the telemetry unit 26 and OSC unit 30 (at Site 2) to the management system 12. Thus, the management system 12 enables supervisory communication between Site 1 and Site 2, which may enable control of gain levels as needed and when it is possible (i.e., when inter-site communication is operational).

The control device 28 may be configured to receive instructions from the management system 12 for controlling the gain level of the Raman amplifier 24. However, according to various embodiments of the present disclosure, some situations may involve controlling the Raman amplifier 24 without direction from the management system 12. Instead, some implementations may involve a step where the control device 28 receives optical parameters (e.g., power) from the local telemetry unit 26. Then, based on these parameters, the control device 28 may be configured to set the gain level of the Raman amplifier 24 to a reduced or clamped level after maintenance or repairs are made to the fiber span 20.

Suppose, for example, that an issue 34 is detected on the fiber span 20, such as a fiber cut, excessively lossy fiber splice, excessive bend in the fiber, pinched fiber, contaminated fiber ends, etc. When maintenance or repairs are performed on the fiber span 20 to correct or remediate these issues, the Raman amplifier 24 is shut off. During maintenance, other pre-existing issues may also be resolved as well. As a result, the overall loss of the fiber span 20 may be reduced below what it had been before maintenance. Therefore, according to the various embodiments of the present disclosure, the control device 28 is configured to clamp the gain level of the Raman amplifier 24 until the actual overall loss of the fiber span 20 can be determined.

### Control Device for Clamping Raman Gain

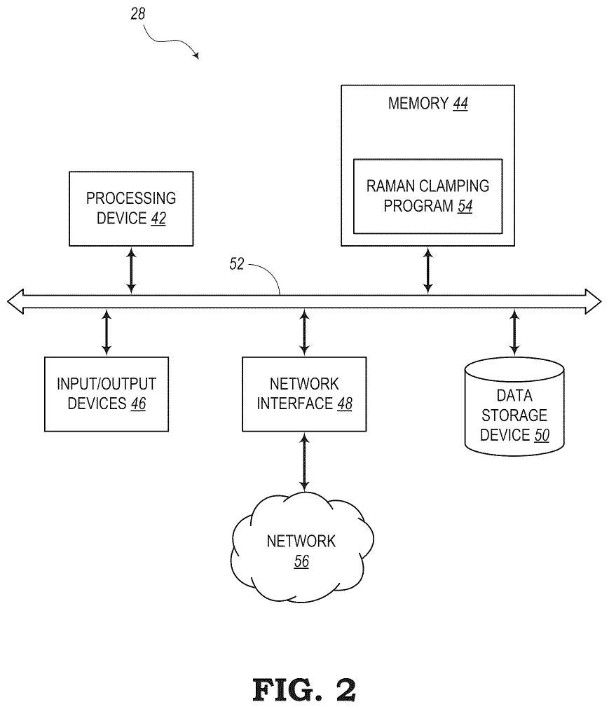

FIG. 2 is a block diagram illustrating an embodiment of the control device 28. In this embodiment, the control device 28 includes a processing device 42, memory 44, Input/Output (I/O) devices 46, a network interface 48, and a data storage device 50. The processing device 42 (e.g., Central Processing Unit (CPU), etc.) is configured to execute instructions stored in the memory 44 to perform various computing tasks. The memory 44 may include volatile memory, such as Random Access Memory (RAM), for temporary data storage and non-volatile memory, such as Read-Only Memory (ROM), for storing essential system instructions.

The I/O devices 46 may facilitate communication with external peripherals and users, including keyboards, mice, displays, printers, etc. The network interface 48 may be configured for communication over a network 56 (e.g., line system 10). The network interface 56 enables data exchange between the control device 28 and external entities, facilitating connectivity and information transfer. In some embodiments, optical parameters measured at Site 2 may be communicated with Site 1, and vice versa, via the network 56.

Additionally, the control device 28 may incorporate various hardware components and subsystems such as Graphics Processing Units (GPUs), sound cards, and expansion slots for accommodating additional peripheral cards. These components enhance the system's capabilities for multimedia processing, audio/video playback, and expansion options for future upgrades or customizations. Furthermore, a bus interface 52 facilitates communication between different internal components, ensuring efficient data transfer and coordination.

The control device 28 may also be equipped with a Power Supply Unit (PSU) to provide electrical power to all internal components, ensuring proper functionality and operation. The PSU may include voltage regulation mechanisms and safety features to protect against power surges and fluctuations, thereby safeguarding the integrity of the system and connected peripherals.

In conjunction with the hardware components, the control device 28 includes software components such as operating systems, device drivers, and application programs. These software elements enable the control device 28 to manage hardware resources efficiently, execute user commands, and run various applications tailored to specific tasks or purposes. Additionally, the control device 28 may incorporate the data storage device 50 (e.g., database) for storing and managing data, providing efficient access and retrieval capabilities.

Overall, the disclosed control device 28 represents a comprehensive platform for performing computational tasks, facilitating communication, and interacting with users and external devices. Its combination of hardware and software components, including the processing device 42, memory 44, I/O devices 46, network interface 48, data storage device 50, and bus interface 52, provide a versatile and scalable computing environment suitable for a wide range of applications across various industries and domains.

In particular, the control device 28 may also include a Raman clamping program 54, which may be implemented in any suitable combination of hardware and software. As shown, the Raman clamping program 54 may be stored in a non-transitory computer-readable (e.g., memory 44) and may include computer logic, code, commands, and/or instructions causing the processing device 42 to execute certain functions for clamping the Raman amplifier 24. The Raman clamping program 54 may be configured to impose a clamping function on Raman gain upon recovery of the fiber span 20 in response to maintenance and repairs, as needed. The Raman clamping program 54 is also configured to ensure recovery of supervisory communications via the management system 12 before relaxing the clamp condition.

### Management System

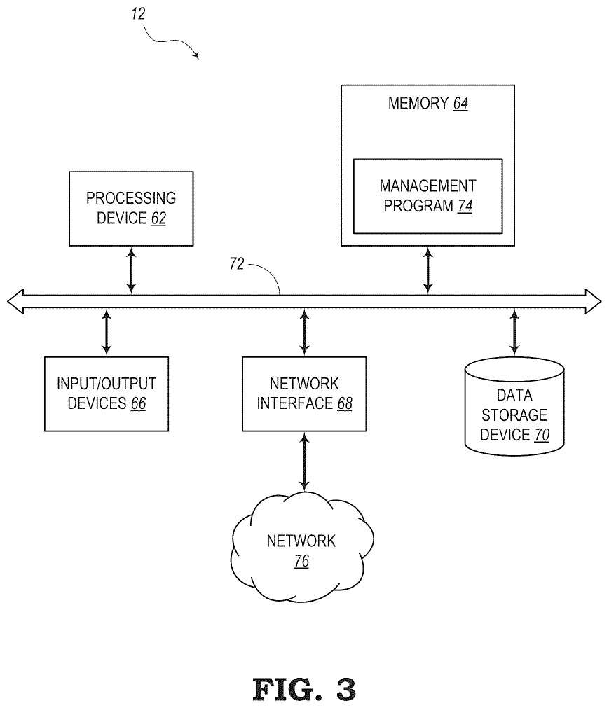

FIG. 3 is a block diagram illustrating an embodiment of the management system 12 shown in FIG. 1. According to some embodiments, the management system 12 may also include a processing device 62, memory 64, I/O devices 66, network interface 68 (for communication over network 76), and data storage device 70, interconnected via a bus interface 72, having essentially the same functionality as described above with respect to FIG. 2. In this embodiment, the management system 12 further includes a management program 74, which may be implemented in any suitable manner in the processing device 62 and/or memory 64. The management program 74 may be stored in non-transitory computer-readable media and may include code or instructions causing the processing device 62 to perform various supervisory, management, or control functions. The management program 74 may be configured to receive OSC and telemetry measurement and may provide supervisory communication between Site 1 and Site 2, via network interface 68 and network 76 (e.g., line system 10).

### Processes for Clamping Raman Gain Levels

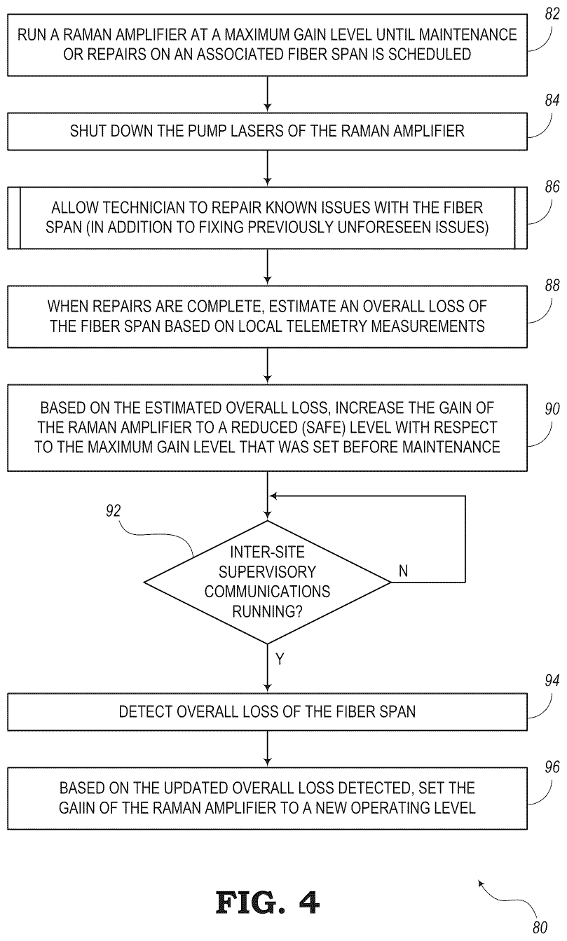

FIG. 4 is a flow diagram illustrating an embodiment of a process 80 for powering up a Raman amplifier upon the remediation of issues on a fiber span. In some embodiments, the process 80 may essentially be executed by the control device 28. As shown in FIG. 4, the process 80 includes a step of running a Raman amplifier at a maximum gain level until maintenance or repairs on an associated fiber span is scheduled, as indicated in block 82. The process 80 further includes a step of shutting down the pump lasers of the Raman amplifier, as indicated in block 84, and then allowing technicians to repair known issues with the fiber span (in addition to fixing previously unforeseen issues), as indicated in block 86.

When repairs are complete, the process 80 also includes a step of estimating an overall loss of the fiber span based on local telemetry measurements, as indicated in block 88. Based on the estimated overall loss, the process 80 further includes a step of increasing the gain of the Raman amplifier to a reduced (safe) level with respect to the maximum gain level that was set before maintenance, as indicated in block 90. Furthermore, the process 80 includes a step of determining if inter-site supervisory communications are running, as indicated in condition block 92. If not, the process 80 loops back to condition block 92 and continues to check until this communication is restored. When the inter-site supervisory communication is running, the process 80 proceeds to block 94, which includes detecting the overall loss of the fiber span. Finally, based on the updated overall loss detection, the process 80 includes setting the gain of the Raman amplifier to a new operating level, as indicated in block 96.

According to various implementations, a controller (e.g., control device 28) may be configured to run locally on the Raman card (e.g., optical amplifier assembly 22). The controller can read the OLF recovery diagnostics. Also, the controller may put a clamp on the maximum achievable Raman gain by clamping the pump powers appropriately. This can be done irrespective of the provisioned target gain from a user or other applications and can remain at the clamped level until OSC-based or other supervisory comms are established with the upstream node (i.e., Site 1). The clamp target, for example, may be proportional to the upstream span loss, estimated from the local telemetry Rx power (e.g., measured by the telemetry unit 26).

The clamp condition can then be removed when supervisory communication is established with the upstream site. For example, such confirmation can come locally if the OSC unit 30 at the Rx (Site 2) is local to the Raman card or optical amplifier assembly 22. Also, confirmation can come from controllers (e.g., control modules, management system 12, etc.) when OSC Loss of Clock (LOC) clears. This may be applicable in the case where OSC Rx (e.g., OSC unit 30) is located on other cards and running under the same control modules.

If the telemetry unit 26 does not detect a Loss of Modulation (LOM) (i.e., “telemetry_loss_of_modulation” =false) and if the OSC unit 30 detects a Loss of Frame (LOF) (i.e., “osc_loss_of_frame”=true), then the control device 28 is configured to keep the Raman gain clamped at the minimum of a) a provisioned target gain, b) a max achievable Raman gain for the specific fiber type of the fiber span, and c) an estimated fiber span loss with the Raman off minus an approximate calculation that ensures avoiding a double Rayleigh Scattering (e.g., 6 dB) (e.g., “estimated_fiber_span loss_with_Raman_OFF”−6 dB).

For example, in optical communications, a Loss of Clock (LOC) error may refer to a situation where the receiver is unable to properly recover the timing information from an incoming signal. and hence cannot correctly interpret the data. LOC issues may be caused by various reasons, such as excessive noise, signal distortion, or synchronization errors between the transmitter and receiver. A Loss of Modulation (LOM) error may refer to a situation where the modulation of the optical signal (i.e., varying the characteristics of a carrier signal in accordance with the information being transmitted) is compromised, which can result in the receiver being unable to extract the transmitted data properly. This can happen due to signal attenuation, dispersion, or interference. A Loss of Frame (LOF) error may refer to a situation where the receiver in the network fails to detect the framing pattern that delineates the boundaries of individual frames of data, which may be caused by synchronization errors, signal degradation, or interference.

The “estimated_span_fiber_loss_with_Raman_OFF” described above may be equal to an estimated power from the upstream telemetry unit 18 minus the power detected by the local telemetry unit 26 with the Raman amplifier 24 off (e.g., “estimated_upstream_telemetry_Tx_pwr”−“local_telemetry_Rx_pwr_with_Raman OFF”). Also, the clamped Raman gain value may be evaluated before turning on the Raman pumps following OLF recovery. Otherwise, if the OSC unit 30 detects an LOF (e.g., “osc_loss_of_frame=false”), then the Raman gain may be set to the minimum of a) the provisioned target gain and b) the maximum achievable Raman gain for the fiber type of the fiber span (“max_achievable_raman_gain_for_fiber_type”).

Therefore, it may be noted that the power-up of the Raman amplifier 24 may rely on local telemetry. Dependency on control modules, the management system 12, and other subtending cards is reduced following OLF recovery and traffic turn-up. This is why it makes sense to implement a recovery procedure based on local card detection and local independent optical sources, other than a total power and OSC involvement. One advantage of using local telemetry signaling is that the telemetry unit 26 may use modulated signals, such as Amplitude Modulation (AM). Another advantage is that transmit end powers are typically fixed. For example, some Raman amplifier cards may be fixed at about +1.7 dBm. If not fixed or reduced for some reason, then limited information on Tx power can be transmitted via AM signaling. Also, one advantage for using local telemetry is that the proposed logic is configured to use telemetry Rx power values to estimate potential fiber span loss (with estimated transmit end power) to clamp the max-achievable Raman gain before the Raman is turned ON following OLF recovery. To recover OLF, either the telemetry Loss of Modulation (LOM) or OSC LOF is configured to be cleared on a span.

In the case of a stretched span, OSC reach usually cannot be accomplished without turning-on the Raman amplifier. In such a case, telemetry LOM clearance is the only way to clear LOF condition and then to turn up Raman to establish OSC comms. Hence, for generalized turn up conditions, OSC normally cannot be relied upon. In shorter spans, OSC could be saturated due to high Raman gain (if the proposed logic is not used to proactively clamp the Raman), and hence, OSC LOF might not be cleared.

Without knowing upstream launch power for traffic spectrum, and OSC launch power, where both could vary since the last known value, it is not ordinarily possible to estimate the incoming span loss following fiber-repair. This information is communicated via OSC or other means of supervisory communications. If OSC LOF is present, no such communications with upstream is typically possible between two sites within an OMS (without some external IP comms, which may be rare, prone to security and traffic congestion issues).

Regarding the control device 28, it may not be desirable to run the control device 28 to check for Raman induced saturation condition on every OSC LOF state since this could negatively impact traffic on the line system 10. Hence, the clamping may be triggered following OLF recovery. However, it is possible to induce the clamp condition on a periodic check if OSC LOF is raised, combined with an increase in telemetry Rx power and the condition remains steady for a given period of time.

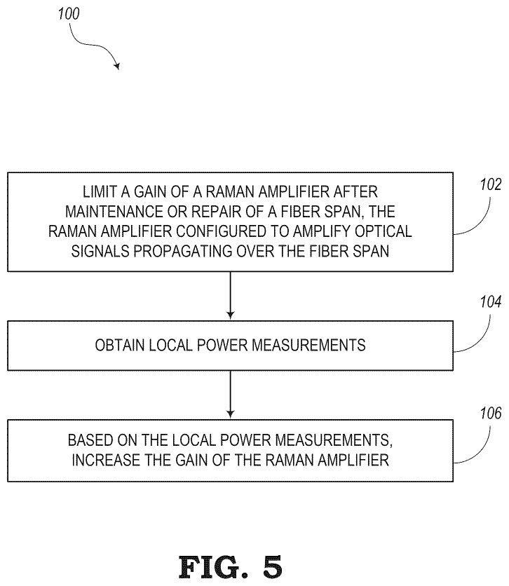

FIG. 5 is a flow diagram illustrating another embodiment of a process 100 for generally limiting the power of a Raman amplifier after issues in a fiber span are resolved. As shown in FIG. 5, the process 100 includes a step of limiting a gain of a Raman amplifier after maintenance or repair of a fiber span, as indicated in block 102, whereby the Raman amplifier is configured to amplify optical signals propagating over the fiber span. The process 100 further includes a step of obtaining local power measurements, as indicated in block 104. Based on the local power measurements, the process 100 further includes a step of increasing the gain of the Raman amplifier, as indicated in block 106.

In some embodiments, the process 100 may be executed by the optical amplifier assembly 22, which includes the Raman amplifier for amplifying optical signals propagating over the fiber span. Also, the optical amplifier assembly 22 may include the control device 28, which may be configured to limit a gain of the Raman amplifier after maintenance or repair of the fiber span 20.

Also, according to further embodiments, the optical amplifier assembly 22 may further include a telemetry Rx component (e.g., telemetry unit 26) configured to obtain power measurements, wherein the control device 28 may be configured to limit the gain of the Raman amplifier to an estimated level based on power measurements. The control device 28 may further be configured to estimate an overall loss of the fiber span based on the power measurements and turn up the gain of the Raman amplifier based on the estimated overall loss. The telemetry Rx component may be configured to output Amplitude Modulated (AM) signals.

Furthermore, the step of limiting the gain (block 102) may include a sub-step of setting the gain to a reduced level corresponding to a reduced overall loss of the fiber span. Also, limiting the gain (block 102) may include setting the gain to a level below a prior setting that had been provisioned before the maintenance or repair of the fiber span. The control device may further be configured to read Optical Line Fail (OLF) recovery diagnostics. The maintenance or repair that is described in block 102 may include reducing an overall loss of the fiber span by performing one or more of a) fixing a fiber cut, b) resplicing a lossy fiber splice, c) reconnecting a loose connector, d) unbending an excessively bent fiber, e) releasing a pinched fiber, f) cleaning an end face of one or more dirty fibers, g) clearing an Optical Line Fail (OLF) condition, h) shortening a length of the fiber span, and i) resolving issues in the fiber span that were unknown at the time when the fiber span was initially installed or when the fiber span received any prior maintenance or repair.

In some embodiments, the fiber span may be configured to link an upstream Network Element (NE) with a downstream NE. The optical amplifier assembly, for example, may be part of the downstream NE. The control device may be configured to limit the gain of the Raman amplifier until supervisory-based communications are established with the upstream NE. The control device in some embodiments may be configured to limit the gain to prevent a saturation condition interrupting Optical Supervisory Channel (OSC) communications between the upstream NE and downstream NE. For instance, an optical fiber may be found to be “saturated” when the fiber's capacity to carry data has been fully utilized or overloaded.

In addition, the control device may be configured to recover from an Optical Line Fail (OLF) by a) clearing a Loss of Modulation (LOM) fault associated with a telemetry unit or b) clearing a Loss of Frame (LOF) fault associated with an Optical Supervisory Channel (OSC) component. When an Optical Supervisory Channel (OSC) associated with the optical amplifier assembly experiences a Loss of Frame (LOF), the gain may be limited to a minimum of a) a provisioned target gain, b) a maximum achievable Raman gain for a fiber type of the fiber span, and c) an estimated fiber span loss with the Raman amplifier off minus an estimated value that would avoid double Rayleigh Scattering. The estimated fiber span loss with the Raman amplifier off, for example, may be equal to an estimated upstream telemetry transmitter power minus a local telemetry receiver power with the Raman amplifier off.

Furthermore, when an Optical Supervisory Channel (OSC) associated with the optical amplifier assembly does not experience a Loss of Frame (LOF), the gain may be limited, in various embodiments, to a minimum of a) a provisioned target gain and b) a maximum achievable Raman gain for a fiber type of the fiber span. The Raman amplifier may be configured for amplification in a direction that is counter to the propagation of the optical signals being amplified. Also, the Raman amplifier may include one or more pump lasers, wherein limiting the gain of the Raman amplifier may include clamping pump power of the one or more pump lasers regardless of previously provisioned target gains. In some embodiments, the optical amplifier assembly may be housed on a Raman card.

According to some embodiments, alternative processes may be employed. For example, instead of implementing the process 100 of FIG. 5, one strategy may include limiting a gain of a Raman amplifier after maintenance or repair of a fiber span, where the Raman amplifier is configured to amplify optical signals propagating over the fiber span. Then, the process may simply include strategically increasing the gain of the Raman amplifier based on local power measurements.

### Additional Considerations

It is believed that the systems and methods described herein introduce a newly recognized issue with respect to powering a Raman amplifier, particularly when the overall loss of a fiber span is reduced (e.g., during a maintenance or repair session resulting in unplanned additional loss reductions). Currently, there is no known system that recognizes this problem. Also, it stands to reason that since the problem has not been addressed until now, the systems and methods of the present disclosure for clamping Raman gain levels after maintenance or repair are novel.

Also, it is believed that there is novelty with respect to clamping Raman gain on fiber recovery (i.e., when the fiber span is restored or recovered from an undesirable condition). The clamping, for instance, is done to ensure supervisory communication has been recovered in the fiber. It is also believed that there is novelty with respect to using local receiver power on an alternative optical source, such as telemetry signals, for span loss estimations to decide on the clamp limit. On clamping Raman gain in one situation, where OSC is in LOF condition and telemetry Rx power has significantly increased for a given period of time, this may indicate a pinch release condition on an active span.

Furthermore, it may be noted that chaotic networks are becoming more common on certain customer bases (e.g., in India, in a recent META example, etc.). These chaotic networks may be characterized in that fiber-plants (e.g., fiber spans) or patch-panels are not installed or inspected carefully before turning up a system live. Thus, one benefit of the present disclosure is that the embodiments described herein add additional robustness on the line system 10 on chaotic networks. Not only will these systems recover Raman amplified links gracefully on fiber span recovery, but also it reduces the potential of fiber and equipment damages due to high Raman power on shorter links.

The Raman amplifier 24 may be configured to pump light backwards (i.e., counter-propagating in the fiber span 20) to amplify across the entire fiber plant or line system 10. By comparison, the EDFAs 14, 32 are each a single device. Raman amplification provides gain over a single span between two sites (e.g., Site 1 and Site 2). Again, the fiber spans may be terminal-to-terminal spans, terminal-to-line amplifier spans, and/or line amplifier-to-line amplifier spans.

Conventionally, when there is a disruption (e.g., fiber cut, maintenance, etc.) and the fiber span or link comes back up, the Raman amplifier normally returns back to its previous provisioned value. However, assuming that, after the disruption, there has been a reduction in the loss of the fiber span (e.g., about 3-4 dB, but perhaps as high as about 10 dB), then this previously provisioned value will be too high for this same span. Again, the span loss may change because something was cleaned up or changed on the span (e.g., lumped loss removed, cleaner fiber, released a pinched fiber, etc.). The problem at that point, however, is that the Raman gain may saturate the fiber span causing one or more negative results. For example, the excess gain may saturate the communication channel (e.g., OSC), which may lead to no comms between the two sites. Also, the excess gain can hurt traffic changes due to so-called double Rayleigh Scattering. Therefore, the systems and methods of the present disclosure are configured to clamp (or limit) the Raman power on restart until it is determined to be safe to increase to a higher level. This can initially be based on local monitoring.

In some embodiments, the OSC providing communication between sites may be implemented at or near 1510 nm (e.g., in a system operating in the C-band) or 1625 nm (e.g., in a system operating in the C+L-band). For example, the OSC may occupy a wavelength of 1516 nm (e.g., C-band) or 1619 nm (e.g., C+L-band). In addition to OSC, telemetry channels may be used and is configured to provide some smaller amount of communication. For instance, OSC (e.g., OC-3) may operate at about 155 megabytes per second, while telemetry may operate at about around one kilobyte per second or less and may be used mainly to determine Raman gain.

To determine Raman gain, either OSC or telemetry channel may be used. The system would know how much power is transmitted (either based on the previous power or it is fixed). For example, the telemetry channel may have a fixed Tx power. The system can also determine Raman gain on the Rx power of this channel—with and without the Raman on. The present embodiments may be configured to detect locally the loss since information about changes to the lumped losses may be unavailable and it would be undesirable, as mentioned herein, to raise Raman gain too high.

### CONCLUSION

Those skilled in the art will recognize that the various embodiments may include processing circuitry of various types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits “configured to” or “adapted to” execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. An optical amplifier assembly comprising:
a Raman amplifier configured to amplify optical signals propagating over a fiber span; and
a control device configured to limit a gain of the Raman amplifier after maintenance or repair of the fiber span.

2. The optical amplifier assembly of claim 1, further comprising a telemetry receiver component configured to obtain power measurements, wherein the control device is configured to limit the gain of the Raman amplifier to an estimated level based on power measurements.

3. The optical amplifier assembly of claim 2, wherein the control device is further configured to estimate an overall loss of the fiber span based on the power measurements and turn up the gain of the Raman amplifier based on the estimated overall loss.

4. The optical amplifier assembly of claim 2, wherein the telemetry receiver component is configured to output Amplitude Modulated (AM) signals.

5. The optical amplifier assembly of claim 1, wherein limiting the gain includes setting the gain to a reduced level corresponding to a reduced overall loss of the fiber span.

6. The optical amplifier assembly of claim 1, wherein limiting the gain includes setting the gain to a level below a prior setting that had been provisioned before the maintenance or repair of the fiber span.

7. The optical amplifier assembly of claim 1, wherein the control device is configured to read Optical Line Fail (OLF) recovery diagnostics.

8. The optical amplifier assembly of claim 1, wherein the maintenance or repair includes reducing an overall loss of the fiber span by performing one or more of a) fixing a fiber cut, b) resplicing a lossy fiber splice, c) reconnecting a loose connector, d) unbending an excessively bent fiber, e) releasing a pinched fiber, f) cleaning an end face of one or more dirty fibers, g) clearing an Optical Line Fail (OLF) condition, h) shortening a length of the fiber span, and i) resolving issues in the fiber span that were unknown at a time when the fiber span was initially installed or when the fiber span received any prior maintenance or repair.

9. The optical amplifier assembly of claim 1, wherein the fiber span is configured to link an upstream Network Element (NE) with a downstream NE.

10. The optical amplifier assembly of claim 9, wherein the optical amplifier assembly is part of the downstream NE, and wherein the control device is configured to limit the gain of the Raman amplifier until supervisory-based communications are established with the upstream NE.

11. The optical amplifier assembly of claim 9, wherein the control device is configured to limit the gain to prevent a saturation condition interrupting Optical Supervisory Channel (OSC) communications between the upstream NE and downstream NE.

12. The optical amplifier assembly of claim 1, wherein the control device is configured to recover from an Optical Line Fail (OLF) by one of a) clearing a Loss of Modulation (LOM) fault associated with a telemetry unit, and b) clearing a Loss of Frame (LOF) fault associated with an Optical Supervisory Channel (OSC) component.

13. The optical amplifier assembly of claim 1, wherein, when an Optical Supervisory Channel (OSC) associated with the optical amplifier assembly experiences a Loss of Frame (LOF), the gain is limited to a minimum of a) a provisioned target gain, b) a maximum achievable Raman gain for a fiber type of the fiber span, and c) an estimated fiber span loss with the Raman amplifier off minus an estimated value that would avoid double Rayleigh Scattering.

14. The optical amplifier assembly of claim 13, wherein the estimated fiber span loss with the Raman amplifier off is equal to an estimated upstream telemetry transmitter power minus a local telemetry receiver power with the Raman amplifier off.

15. The optical amplifier assembly of claim 1, wherein, when an Optical Supervisory Channel (OSC) associated with the optical amplifier assembly does not experience a Loss of Frame (LOF), the gain is limited to a minimum of a) a provisioned target gain, and b) a maximum achievable Raman gain for a fiber type of the fiber span.

16. The optical amplifier assembly of claim 1, wherein the Raman amplifier is configured for amplification in a direction that is counter to propagation of the optical signals being amplified.

17. The optical amplifier assembly of claim 1, wherein the Raman amplifier includes one or more pump lasers, wherein limiting the gain of the Raman amplifier includes clamping pump power of the one or more pump lasers regardless of previously provisioned target gains.

18. The optical amplifier assembly of claim 1, wherein the optical amplifier assembly is housed on a Raman card.

19. A method comprising steps of:
limiting a gain of a Raman amplifier after maintenance or repair of a fiber span, the Raman amplifier configured to amplify optical signals propagating over the fiber span;
obtaining local power measurements; and
based on the local power measurements, increasing the gain of the Raman amplifier.

20. A controller comprising:
a processing device; and
memory configured to store computer logic having instructions that, when executed, cause the processing device to
limit a gain of a Raman amplifier after maintenance or repair of a fiber span, the Raman amplifier configured to amplify optical signals propagating over the fiber span, and
increase the gain of the Raman amplifier based on local power measurements.
